(19) United States
(12) Patent Application Publication
(10) Pub. No.: US 2025/0315675 A1
(43) Pub. Date: Oct. 9, 2025

(54) REAL-TIME PRUNING METHOD AND SYSTEM FOR NEURAL NETWORK, AND NEURAL NETWORK ACCELERATOR

(71) Applicant: LONGANPI (SHANGHAI) INTELLIGENT INFORMATION TECHNOLOGY CO., LTD., Shanghai (CN)

(72) Inventors: Hang LU, Beijing (CN); Hongyan LI, Beijing (CN); Xiaowei LI, Beijing (CN)

(73) Assignee: LONGANPI (SHANGHAI) INTELLIGENT INFORMATION TECHNOLOGY CO., LTD., Shanghai (CN)

(21) Appl. No.: 18/561,160

(22) PCT Filed: Feb. 22, 2022
(86) PCT No.: PCT/CN2022/077281

§ 371 Date: Nov. 15, 2023

(30) Foreign Application Priority Data
Aug. 20, 2021 (CN) 202110960966.X

(51) Int. Cl. G06N 3/082

(52) U.S. Cl. CPC G06N 3/082

(57) ABSTRACT

The application provides a hardware-based real-time pruning method and system for a neural network, and a neural network accelerator. The method comprises: acquiring, from a neural network model, a bit matrix to be subjected to matrix multiplication, and taking the Euclidean distance product of each bit row and each bit column of the bit matrix as the significance of each bit row of the bit matrix in a matrix multiplication operation; and classifying each bit row of the bit matrix into a significant row or an insignificant row according to the significance, and taking a matrix, which is obtained after bit positions that are 1 in the insignificant row of the bit matrix are set to 0, as a pruning result of the bit matrix. The pruning of the application does not rely on software, is independent of the existing software pruning method and supports multiple accuracy DNNs.

### BACKGROUND OF THE APPLICATION

### 1. Technical Field

The present application relates to the field of deep neural network model pruning technique, and particularly to a real-time pruning method and system for a neural network, and a neural network accelerator.

### 2. Related Art

With rapid evolution of the number of parameters in deep learning models from millions (such as, ResNet series in computer vision) to even hundreds of billions (such as, BERT or GPT-3 in natural language processing), huge computation becomes one of the main obstacles in deployment of deep neural networks (DNNs) to actual application. Although the models having deeper level and more complex neuron connection provide good guarantee for growing demand of accuracy, as for more important real-time requirement, they do not follow development of the DNNs. The problem is especially prominent on resource limited devices.

With respect to the problem, the neural network pruning technique is acknowledged to be an effective way of obtaining good accuracy of the model and reducing computation. However, almost all traditional pruning methods rely on software level, and such pruning often comprises steps of: (1) determining the significance of neurons according to significance index; (2) deleting insignificant partial neurons according to a preset compression ratio; (3) finely tuning the network to restore accuracy, or adjusting the significance index and restarting pruning again in the case of a low accuracy.

However, due to diversity of deep learning application, it is difficult to find a general-purpose software-based pruning method. Therefore, terminal users must reconsider pruning standard for specific application according to hyper-parameters and structural parameters of the DNN, and carry out the steps again from the beginning for pruning. Such tedious, time-consuming and repeated tasks limit rapid deployment of the DNN in actual use. The problems and reasons of such pruning method are mainly in the following three aspects:

(1) As is viewed from the model, sparsity of the DNN model itself is adverse to software pruning. Specifically, pruning determines insignificant parameters using one significance index. The index measures sparsity of weights and activations from different angles, for example, a ratio of 0 in the activations, significance of the filter determined based on L1-norm, information entropy of the filter, and the like. Such index attempts to prune zero or parameters close to zero, and then retrain the model till reaching the optimum accuracy. However, one index may be suitable for some DNN models, but not applicable for other DNNs. Moreover, sparsity space of the model itself is not always enough. Therefore, some pruning methods must perform time-consuming sparse training to increase sparsity of parameters, and perform retraining or fine tuning to make up for lost accuracy after loss of accuracy.

(2) As is viewed from efficiency, the software pruning method consumes time and labor at fine tuning/retraining phase, because the parameters left after pruning cannot ensure that the model can reach the original accuracy before pruning. Therefore, the traditional method must rely on retraining/fine tuning performed on the same data set to make up for loss of accuracy. However, retraining/fine tuning often shall experience iteration of several days or weeks, and the program is often implemented layer by layer. If we apply pruning to VGG-19, the model shall be retrained 19 times, and iterated dozens of epochs each time to restore the lost accuracy. Time-consuming iteration hinders deployment of the pruned model to devices. Moreover, if accuracy is poor after pruning, the above steps shall be repeated. Considering of other universal networks having hundreds of layers (ResNet, DenseNet), or 3D convolution, non-local convolution and deformable convolution having more and complex connections, developers often face the inevitable challenge of obtaining good accuracy and taking less time simultaneously.

(3) As is viewed from the accelerator, firstly, non-structural pruning largely relies on hardware. The previous search proposes a large number of accelerators for specific pruning, for example, Cambricon-S for solving irregularity of the non-structural pruning, EIE with a fully connected layer, and ESE with a long short-term memory (LSTM) network model, but these accelerators do not support computation of the main body, i.e., a convolutional layer, in inference and computation of the convolutional neural network. Secondly, design of the accelerators also relies on different sparse methods. SCNN explores sparsity of neurons and synapses. However, Cnvlutin only supports sparsity of neurons. Therefore, if software developers change the pruning strategy or only adjust from structural pruning to non-structural pruning, hardware deployment also must be changed, which introduces cost of migration.

In an ideal case, the pre-trained DNN shall prune on hardware as quickly as possible. Even further, the hardware shall directly carry out pruning in an efficient and convenient manner, instead of accelerating DNN inference through tedious operation on a software level. As for most software pruning methods, the traditional pruning steps comprise identifying and pruning insignificant parameters. However, as is stated above, since sparsity space based on values is quite limited, if the compression ratio is too large, it inevitably leads to serious loss of accuracy. If such case occurs, the traditional pruning uses the following two solutions: \textcircled{1} reducing the compression ratio, and pruning again from the beginning, and \textcircled{2} creating more sparsity space for pruning using sparse training. The reason why pruning is time-consuming on the software level is also originated from this.

### SUMMARY OF THE APPLICATION

An object of the application is to solve the problem of efficiency of pruning in the prior art, and the application provides a hardware pruning method for DNN parameter bits, i.e., BitX, and designs a hardware accelerator for carrying out BitX pruning algorithm. The application comprises the following key technical points:

Key point 1, BitX hardware pruning algorithm. Pruning provided in the application is a pruning method based on valid bits, the application provides a plurality of methods of how to determine validity of bits, and the technical effect is that the method for determining validity of bits in the application performs pruning without the aid on a software level, is independent of the existing software pruning method and supports multiple accuracy DNNs, i.e., pruning based on valid bits can be implemented based on hardware.

Key point 2, design of architecture of the hardware accelerators. The technical effect is that the hardware accelerators may implement BitX pruning algorithm on the hardware level.

Specifically, with respect to deficiencies of the prior art, the application provides a real-time pruning method for a neural network, comprising:
step 1, acquiring, from a neural network model, a bit matrix to be subjected to matrix multiplication, and taking the Euclidean distance product of each bit row and each bit column of the bit matrix as the significance of each bit row of the bit matrix in a matrix multiplication operation; and
step 2, classifying each bit row of the bit matrix into a significant row or an insignificant row according to the significance, and taking a matrix, which is obtained after bit positions that are 1 in the insignificant row of the bit matrix are set to 0, as a pruning result of the bit matrix.

In the real-time pruning method for a neural network, the step 1 comprises the significance of each bit row of the bit matrix in a matrix multiplication operation obtained through the following formula:

$${p}_{i} = \frac{\sqrt{{( {2}^{{E}_{i}} )}^{2} \times BitCnt ( i )}}{C}$$

$$C = {\sum }_{{i}^{′} = 1}^{l} \sqrt{{( {2}^{{E}_{{i}^{′}}} )}^{2} \times BitCnt ( {i}^{′} )}$$

wherein pᵢ is the significance of the i-th bit row of the bit matrix in the matrix multiplication operation, Eᵢ is a bit value of the i-th bit row element, BitCnt(i) is a valid bit number in the i-th bit row, and l is the number of columns of the bit matrix.

The real-time pruning method for a neural network, before executing the step 1, acquiring a plurality of original weights to be subjected to the matrix multiplication operation, determining whether the original weights are fixed-point numbers, if yes, executing the step 1, or uniformly aligning all mantissas of the original weights to the maximum level code of the plurality of original weights, taking the aligned matrix as the bit matrix, and executing the step 1.

In the real-time pruning method for a neural network, the bit matrix is a weight matrix and/or an activation matrix; and the step 2 comprises: dividing N bit rows with the highest significance in the bit matrix into significant rows, where N is a positive integer, and less than a total number of bit rows of the bit matrix.

The application further provides a real-time pruning system for a neural network, comprising:
a module 1 for acquiring, from a neural network model, a bit matrix to be subjected to matrix multiplication, and taking the Euclidean distance product of each bit row and each bit column of the bit matrix as the significance of each bit row of the bit matrix in a matrix multiplication operation; and
a module 2 for classifying each bit row of the bit matrix into a significant row or an insignificant row according to the significance, and taking a matrix, which is obtained after bit positions that are 1 in the insignificant row of the bit matrix are set to 0, as a pruning result of the bit matrix.

In the real-time pruning system for a neural network, the module 1 comprises the significance of each bit row of the bit matrix in a matrix multiplication operation obtained through the following formula:

$${p}_{i} = \frac{\sqrt{{( {2}^{{E}_{i}} )}^{2} \times BitCnt ( i )}}{C}$$

$$C = {\sum }_{{i}^{′} = 1}^{l} \sqrt{{( {2}^{{E}_{{i}^{′}}} )}^{2} \times BitCnt ( {i}^{′} )}$$

wherein pᵢ is the significance of the i-th bit row of the bit matrix in the matrix multiplication operation, Eᵢ is a bit value of the i-th bit row element, BitCnt(i) is a valid bit number in the i-th bit row, and l is the number of columns of the bit matrix.

The real-time pruning system for a neural network, before calling the module 1, acquiring a plurality of original weights to be subjected to the matrix multiplication operation, determining whether the original weights are fixed-point numbers, if yes, calling the module 1, or uniformly aligning all mantissas of the original weights to the maximum level code of the plurality of original weights, taking the aligned matrix as the bit matrix, and calling the module 1.

In the real-time pruning system for a neural network, the bit matrix is a weight matrix and/or an activation matrix; and the module 2 comprises: dividing N bit rows with the highest significance in the bit matrix into significant rows, where N is a positive integer, and less than a total number of bit rows of the bit matrix.

The application further provides a neural network accelerator applied to the real-time pruning system for a neural network.

The neural network accelerator comprises a PE formed of a plurality of CUs, each CU receiving a plurality of weight and activation pairs as inputs, and pruning processing on the input weights is performed by the module 2.

In the neural network accelerator, each selector of extractors in the CU is configured for a binary weight after pruning, and the extractors record the actual values of bits in each significant row for shifting the corresponding activations.

The application further provides a server comprising a storage medium, wherein the storage medium is configured to store and execute the real-time pruning method for a neural network.

As for the BitX accelerator provided in the application, BitX-mild and BitX-wild acceleration architectures may be formed according to different configurations, and the technical effects are as follows:
(1) Speed enhancement: BitX-mild and BitX-wild may obtain 2.61 to 4.82× acceleration in the 32-bit floating-point number mode as compared to the unpruned model, and may reach 2.00× acceleration in the 16-bit fixed-point number mode. With respect to object detection, as compared to the original model YoloV3, the speed is improved by 4.98 times and 14.76 times.
(2) Accuracy rate: in ImageNet data set, losses of the accuracy rate are 0.13% and 0.44% respectively using BitX-mild and BitX-wild pruning, and in Cifar-10 data set, they are 0.09% and 0.15%. The above accuracy data are based on the 32-bit floating-point number mode. In the 16-bit fixed-point number mode, as for BitX-mild, the accuracy rate is 0.9% and 0.2% higher than that of the original DenseNet121 and ResNext101 models, and as for BitX-wild, the accuracy rate is 0.8% and 0.1% higher. As for YoloV3, the accuracy rate of BitX-mild is 0.06% and 0.07% higher than the original models, and the accuracy rate of BitX-wild is 0.31% and 1.64% lower.
(3) Performance of the accelerator: as compared to design of other most advanced accelerators, the BitX accelerator achieves 2.00× and 3.79× performance enhancement. In the TSMC 28nm process, the accelerator has an area of 0.039 mm², and power of 68.62 mW (32-bit floating-point number mode) and 36.41 mW (16-bit fixed-point number mode).

### BRIEF DESCRIPTION OF THE DRAWINGS

FIG. 1 is an analysis diagram of distribution of bits 1.

FIG. 2 is a concept diagram of BitX core according to the application.

FIG. 3 is a structural diagram of an accelerator of the application.

FIG. 4 is a structural diagram of a CU in the accelerator of the application.

### DETAILED DESCRIPTION

Considering of deficiencies of the traditional pruning and necessity of the demand for efficient pruning, we reconsider the exiting pruning method, and make sparsity analysis on bit-level parameters. The application explores a new pruning method, and improves pruning efficiency. Result of sparsity analysis on the bit-level parameters is mainly as follows:

TABLE 1
Comparison of weight/bit sparsity of different pre-training models,
wherein weights are represented by 32-bit floating-point numbers,
and bit sparsity is obviously greater than weight sparsity

| Model | Weight Sparsity | Bit Sparsity |
|---|---|---|
| DenseNet121 | 4.84% | 48.64% |
| ResNet50 | 0.33% | 48.64% |
| ResNet152 | 0.75% | 48.64% |
| ResNext50_32x4 d | 0.37% | 48.64% |
| ResNext101_32x8 d | 3.43% | 48.65% |
| InceptionV3 | 0.05% | 48.64% |
| MNASNet0.5 | 0.00% | 48.60% |
| MNASNet1.0 | 8.07% | 48.98% |
| MobileNetV2 | 0.01% | 48.67% |
| ShuffleNetV2_x0_5 | 0.00% | 48.36% |
| ShuffleNetV2_x1_0 | 1.53% | 48.63% |
| SqueezeNet1_0 | 0.05% | 48.64% |
| SqueezeNet1_1 | 0.02% | 48.64% |

As shown in Table 1, weight sparsity is obtained by comparison of the number of weights less than 10⁻⁵ and a total number of weights, and bit sparsity is obtained by comparison of the number of bits that are 0 in the mantissa and a total number of bits. Obviously, as for two sparsity indexes, all models exhibit obvious difference. Weight sparsity of most models is 1% or less, while bit sparsity reaches 49%. This provides a good chance for exploring bit-level sparsity. Since 49% or more of the bits are 0, pruning these invalid bits ambiguously does not produce any influence on accuracy. The application makes full use of this good condition to accelerate DNN inference.

49% of bits to be 0 also mean that 51% of bits are 1, and also occupy a large part of parameter bits. However, not all bits 1 produces influence on the final accuracy. Therefore, a part of bits 1 is the bits 1 with extremely small actual values, and is a factor that affects the computing efficiency (the factor is never considered in the previous search). After exploring bit-level sparsity, we further move the technical direction towards invalid bits 1 (tiny influence).

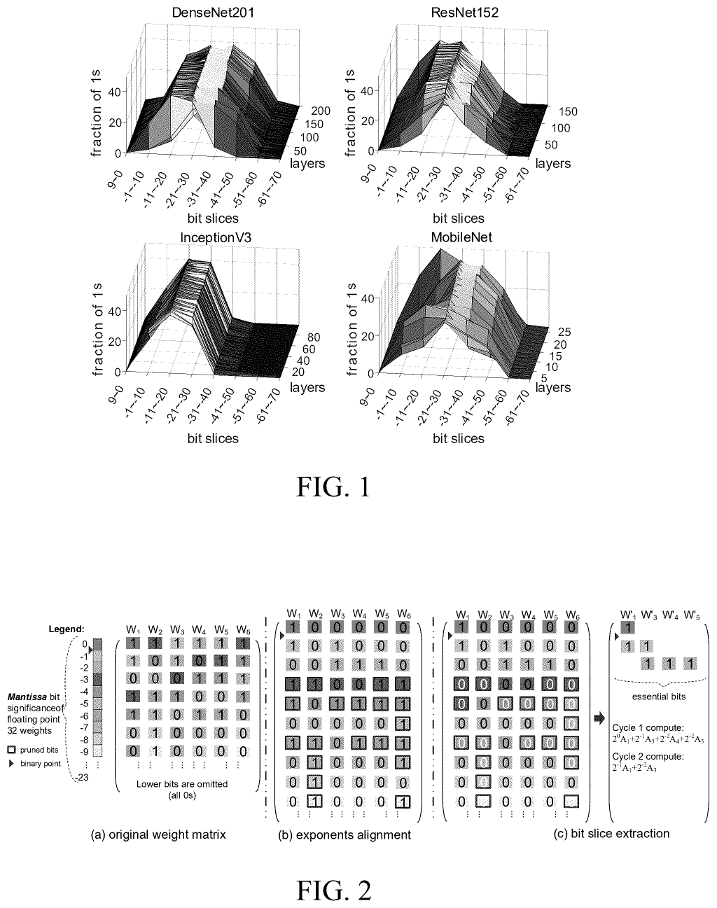

Therefore, we search distribution of the bits 1 using bit distribution (a range of every 10 level codes as a slice) as a unit. As shown in FIG. 1, an x axis represents bit slices of the binary (represented by 32-bit floating points) weights, and each bit slice represents a bit value on the position. Assuming that one weight bit 1.1101×2⁻⁴ is represented to be 0.00011101 in the binary system, we record that the bit values of the four valid bits 1 are 2⁻⁴, 2⁻⁵, 2⁻⁶ and 2⁻⁸, respectively.

As shown in FIG. 1, four standard DNN models are distributed in a similar way that a peak in the three-dimensional diagram reaches at a horizontal coordinate 2⁻²¹ to 2⁻³⁰, which means that the bit value of the range covers most of bits 1 (about 40%), but most of bits 1 have weak influence on accuracy of inference. BitX of the application aims to prune these bits to accelerate inference. After binary conversion, a range of the bit slices is changed from 2⁹˜2⁰ to 2⁻⁶¹˜2⁻⁷⁰. All models are in an “arch shape” on each layer. Most of (40%) bits 1 are in the middle of the bit slices. Taking 2⁻²¹ to 2⁻³⁰ for example, the corresponding denary range is 0.000000477 (about 10⁻⁸) to 0.000000000931 (about 10⁻¹¹). However, actually, such small bit1 values have very small influence on accuracy of the model. Therefore, the application aims to accurately identify significant bits and prune most of bits that have little influence on the accelerator to reach the object of reducing computation in the case of small accuracy loss.

A floating-point operand is consisting of three parts, a sign bit, a mantissa and an exponent, and follows the most common floating-point standard in the industry, i.e., the standard IEEE754. If we use single accuracy floating-point number (fp32), a bit width of the mantissa is 23 bits, a bit width of the exponent is 8 bits, and the remaining bit is the sign bit. One single accuracy floating-point weight may be represented by fp=(−1)^{s}1·m×2^{e-127}, and e is adding 127 at the actual position of decimal point of the floating-point number.

Taking six unaligned 32-bit single accuracy floating-point weights for example, the mantissa is represented in FIG. 2. A weight bit matrix is obtained, and each column of the matrix represents binary mantissa values actually stored in the memory. Different colors in the example represent bit values from 2⁻¹ to 2⁻⁹ (the bit value 2⁰ represents hidden 1 in the mantissa). In the weight bit matrix, according to different exponents, we use different background colors to represent the actual values on the bits. For example, the uppermost dark gray in W₂ represents the bit value 2⁻³.

As shown in FIG. 2(b), all mantissas are aligned according to the exponents, so the upper portion of the matrix has a large number of filled 0. Firstly, such phenomenon causes an increase of sparsity after filing 0, and provides good conditions for bit-level pruning. Secondly, most of bits 1 are shifted to the mantissa with bit values less than 2⁻⁶. Such bits 1 have very little influence on the final Multiply-Accumulate operation (MAC). If these insignificant bits 1 are pruned, a large number of bit-level operations can be omitted, thereby accelerating inference. As shown in FIG. 2(c), the red block represents the pruned 1, only leaving a few critical bits 1 to form pruned weights: W′₁, W′₃, W′₄ and W′₅, and these bits are referred to as “essential bits”.

It is an effective way to simplify MAC on the bit level using “essential bits” in FIG. 2(c). However, as for millions of parameters, influence of one separate bit on the entire network is difficult to be evaluated. Therefore, the application provides an effective but hardware friendly mechanism BitX to make full use of invalid bits, and can still retain the original accuracy without the aid of time and labor consuming software pruning methods.

### (1) BitX Pruning Method:

Given one n×l matrix A and l×n matrix W, a result of A×W can be represented by a sum of n rank-one matrices. The result of A×W can be obtained by Fast Monte-Carlo Algorithm (Fast Monte-Carlo Algorithm randomly samples some rank-one matrices to approximate matrix multiplication, and the most common sampling method is to compute the corresponding probability to select these rank-one matrices). As shown in formula (1), A⁽ⁱ⁾ represents the i-th row of the matrixA, and W₍ᵢ₎ represents the i-th column of the matrixW. The application reflects the significance of one rank-one matrix multiplication in the sum of n rank-one matrix products by computing a product of Euclidean distance of A⁽ⁱ⁾ and W₍ᵢ₎ as a sampling probability.

$${p}_{i} = \frac{\vert {A}^{( i )} \vert \vert {W}_{( i )} \vert}{{\sum }_{{i}^{′} = 1}^{l} \vert {A}^{( i )} \vert \vert {W}_{( i )} \vert} \qquad ( 1 )$$

Under inspiration from Fast Monte-Carlo Algorithm, we measure the significance of bits in the weights, rather than the significance of values in the BitX using the sampling probability. As compared to other more significant bits in the same weight, the bits having smaller probability have little influence when multiplying by the activations. Therefore, the application abstracts the bit matrix in FIG. 2(a) to be W, finds (in)significant bit rows in FIG. 2(b), samples each bit row in W using the probability of formula (1), and determines the bit rows to be pruned, thereby simplifying computation of MAC.

In the weight matrix, the application is targeted at a mantissa part of n 32-bit floating-point weights, and the mantissa of each weight is instantiated to column vectors consisting of bit values. As for MAC, n weights mean n activations correspondingly, and n activations form another column vector [A₁, A₂ . . . Aⱼ . . . Aₙ]^{T}. Formula 2 can be obtained by putting a column vector of the activation matrix and a row vector of the weight matrix into formula 1:

$${p}_{i} = \frac{\vert {A}^{( i )} \vert \times \sqrt{{\sum }_{j = 1}^{n} {( {2}^{{E}_{i}^{j}} \times {v}_{j} )}^{2}}}{{\sum }_{{i}^{′} = 1}^{l} ( \vert {A}^{( i )} \vert \times \sqrt{{\sum }_{j = 1}^{n} {( {2}^{{E}_{i}^{j}} \times {v}_{j} )}^{2}} )} \qquad ( 2 )$$

wherein Aⱼ is an element of the activation vector, and vⱼ is the j-th element of the i-th row vector in the weight bit matrix. The same row in the weight bit matrix has the same exponent (level code). Therefore,

$${E}_{i}^{j}$$

in formula (4) represents a level code of the j-th element. The Euclidean distance of the row vectors is computed by

$$\sqrt{{\sum }_{j = 1}^{n} {( {2}^{{E}_{i}^{j}} \times {v}_{j} )}^{2}} .$$

Exponent alignment operation in the BitX is almost consistent with that in the floating-point addition. The only difference is that BitX aligns a group of numbers to the maximum level code simultaneously, instead of aligning between the weights/activations one by one. Therefore, after exponent alignment, the same row in the weight bit matrix has the same exponent (level code), as shown in FIG. 2(b). We use a uniform Eᵢ to represent the actual level code of the i-th row bit vectors. Moreover, the pruning solution of the application may be applied to the weight matrix and/or activation matrix.

v represents a bit row vector of W, and if one element vⱼ in v is equal to 0, it does not produce any influence on computing the Euclidean distance, and hence have no influence on pᵢ. Therefore, computing the Euclidean distance is converted into computing the number of bits 1 of the i-th row vector. BitCnt(i) is used to represent this numerical value. Therefore, pᵢ may be modified to formula 3:

$${p}_{i} = \frac{\vert {A}^{( i )} \vert \times ( \sqrt{{( {2}^{{E}_{i}} )}^{2} \times BitCnt ( i )} )}{\vert {A}^{( {i}^{′} )} \vert \times {\sum }_{{i}^{′} = 1}^{l} ( \sqrt{{( {2}^{{E}_{{i}^{′}}} )}^{2} \times BitCnt ( {i}^{′} )} )} = \frac{\sqrt{{( {2}^{{E}_{i}} )}^{2} \times BitCnt ( i )}}{{\sum }_{{i}^{′} = 1}^{l} \sqrt{{( {2}^{{E}_{{i}^{′}}} )}^{2} \times BitCnt ( {i}^{′} )}} \qquad ( 3 )$$

In formula 3, Eᵢ represents the level code of the i-th row vector. All column vectors in the matrix A are the same. Therefore, |A^{(1′)}| is equal to |A⁽ⁱ⁾. As for the given matrix W having l column vectors,

$${\sum }_{{i}^{′} = 1}^{l} \vert {W}_{( i )} \vert$$

is a constant value, so if C=

$${\sum }_{{i}^{′} = 1}^{l} \sqrt{{( {2}^{{E}_{{i}^{′}}} )}^{2} \times BitCnt ( {i}^{′} )} ,$$

finally, pᵢ is simplified to formula 4:

$${p}_{i} = \frac{\sqrt{{( {2}^{{E}_{i}} )}^{2} \times BitCnt ( i )}}{C} \qquad ( 4 )$$

In formula 4, pᵢ reflects the significance of the bit row i of the bit matrix in computation. Therefore, Eᵢ reflects a size of bit values of the i-th row element, and BitCnt(i) reflects the number of valid bits in the i-th row, where the valid bits are bit1, and correspondingly, the invalid bits are bit0. The larger Eᵢ and BitCnt(i) have greater influence on the final MAC. BitX determines the significant bits using formula 4, while directly pruning insignificant bits in the accelerator.

### (2) BitX Pruning Program:

Algorithm 1:BitX pruning procedure.
Input: n number of fp32 weights, and bit-sparsity levelN
Output: essential bit matrix W′

| | |
|---|---|
| 1: | Interpret n exponentsE = [e₁ . . . , eₙ] and mantissas M = |
| | [m₁, . . . , mₙ]; |
| 2: | Adding the hidden ′1′ and obtain M′ = [m′₁, . . . , m′ₙ]; |
| 3: | Align M′ with eₘₐₓ = max(E) and obtain updated M′ |
| 4: | Obtain bit matrix W with each m′ ∈ M′ in column #2 (a) |
| 5: | r, c = W.shape #matrix row and column |
| 6: | mask = zeros(r); #initialize mask_{r×1} with 0 |
| 7: | foreach row iinW: #iterate each row in W |
| 8: 9: | ${E}_{i} = {e}_{i} - {e}_{max} {p}_{i} = {2}^{{E}_{i}} \times \sqrt{BitCnt ( i )} / C \# \qquad Eq . ( 4 )$ |
| 10: | P.append(pᵢ)#P stores each pᵢ |
| 11: | I, P′ = sort(P); #sort P in descending order, obtain index vector I |
| 12: | I′ = max(I, N); #I′ = [i₁, . . . , i_{N}], obtain the first N indices |
| 13: | foreach index i inI′: |
| 14: | mask[i] = 1 |
| 15: | W ← W ⊗ mask# prune W with mask, 2(c) |
| 16: | n = 0 |
| 17: | ¹foreach each row i inW: |
| 18: | foreach column j inW: |
| 19: | ifW(i, j) = = 1: |
| 20: | W′(i, n) = 1 |
| 21: | n += 1 |
| 22: | n = 0 #reset n for the next row |
| 23: | return W′ #essential bit matrix |

¹The outer “foreach” loop could be parallelized in hardware.

The algorithm of the application is described to be the above algorithm 1. Firstly, BitX extracts a level code E and a mantissa M of the 32-bit floating-point weights as inputs (the first to third rows), then uniformly aligns all mantissas to the maximum level code eₘₐₓ (the fourth row), computes pᵢ, and sorts pᵢ in a descending order (the fifth to tenth rows). The input parameter N represents the number of remaining bit row vectors after pruning W, i.e., BitX selects the bit rows having the maximum Nₚᵢ. The selected N row indices are stored in the array I (the thirteenth row). Pruning is finally implemented by mask. After pruning, BitX extracts all critical bits 1, and saves back to W′.

Design parameter N in the algorithm controls a particle size of pruning. A smaller N controls the algorithm to produce a larger bit sparsity, further prune more rows, and finally accelerate inference by skipping more 0.

### (3) Hardware Pruning Accelerator of BitX

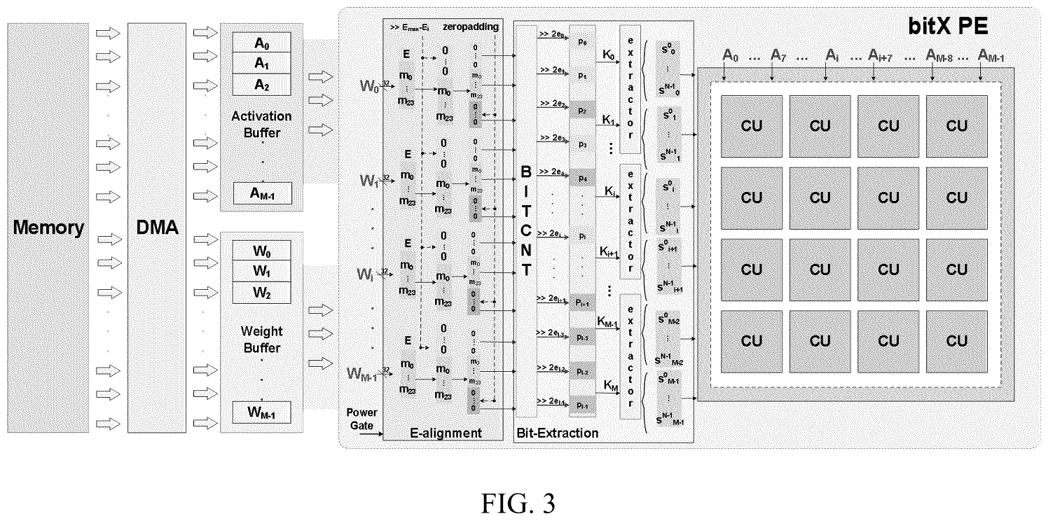

System structure of the accelerator is shown in FIG. 3. “E-alignment” and “Bit-Extraction” modules are configured to execute Bit pruning algorithm. Every 16 computing units (CU) form a BitX processing element (PE). Each CU receives M weight/activation pairs as inputs. The input weights are pre-processed by the “Bit-Extraction” module, and the bits with small actual values are pruned to be 0. As for the fixed-point DNN, the E-alignment module is undesired, and since the fixed-point operation does not involve the exponent alignment operation, the original weights are directly inputted to “Bit-Extraction”.

### \textcircled{1} E-Alignment Module

The E-alignment module aligns all weights to the maximum level code. The module is mainly formed of a data shifting component and a zero bit filling component. As for floating-pointing data, weight parameters are firstly modified to the corresponding mantissa and level code. Moreover, the maximum level code is obtained, and other weights are uniformly aligned to the maximum level code. The data shifting component completes such operation by right shifting the i-th mantissa by Eₘₐₓ−Eⱼ. Vacancies at a front portion of the mantissa caused by shifting are filled with bits 0 (light gray marked in FIG. 3) through the filling member. As for different weights, Eᵢ may not be completely the same, so after filling with bits 0, bit widths of all parameters are inconsistent. In order to handle such case, zero bit filling also will fill a series of zero bits to the maximum bit width (dark gray marked in FIG. 3).

### \textcircled{2} Bit Extraction Module

The mantissa outputted from the E-alignment module is inputted into the Bit-Extraction module for bit pruning. The first functional unit of the module is BITCNT for implementing the BitCnt function in formula (4). The second function of the Bit-Extraction module is to sort BitCnt(i) after shifting, and select row with the first largest value of pi or rows with the first n largest values of pᵢ, n is a positive integer greater than or equal to 2, and weights in other rows are pruned. Finally, the pruned weights are obtained.

### \textcircled{3} Compute Unit (CU)

Bit sparsity space of the pruned weights is improved, so the design designs a skipping mechanism in “extractor” of the “Bit-Extraction” module, and further sends the critical bits to the computing unit (CU) module.

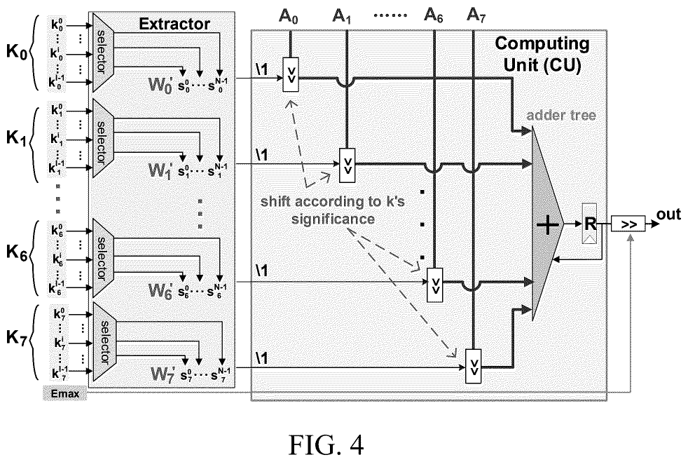

Microstructure of the CU is shown in FIG. 4. Each “selector” in the extractors is for a binary weight (total M weights) after pruning, and k represents essential bits in the pruned weights. Extractors record the actual value of each essential bit, which is represented by s, for shifting the corresponding activations.

Activations can be floating-point data or fixed-point data. The fixed-point activations can be directly shifted. However, as for the floating-point activations, shifting operation is to accumulate level codes in the activations, and is also actually fixed-point operation. Therefore, the shifter does not introduce a large cost. An adder tree executes the final partial sum accumulation, while also distinguishes different accuracies.

Hereinafter system embodiment corresponding to the method embodiment is explained, and this embodiment can be carried out combining with the above embodiment. The relevant technical details mentioned in the above embodiment are still effective in this embodiment, and in order to reduce repetition, the details are not described here. Correspondingly, relevant technical details mentioned in this embodiment also can be applied to the above embodiment.

The application further provides a real-time pruning system for a neural network, comprising:
a module 1 for acquiring, from a neural network model, a bit matrix to be subjected to matrix multiplication, and taking the Euclidean distance product of each bit row and each bit column of the bit matrix as the significance of each bit row of the bit matrix in a matrix multiplication operation; and
a module 2 for classifying each bit row of the bit matrix into a significant row or an insignificant row according to the significance, and taking a matrix, which is obtained after bit positions that are 1 in the insignificant row of the bit matrix are set to 0, as a pruning result of the bit matrix.

In the real-time pruning system for a neural network, the module 1 comprises the significance of each bit row of the bit matrix in a matrix multiplication operation obtained through the following formula:

$${p}_{i} = \frac{\sqrt{{( {2}^{{E}_{i}} )}^{2} \times BitCnt ( i )}}{C}$$

$$C = {\sum }_{{i}^{′} = 1}^{l} \sqrt{{( {2}^{{E}_{{i}^{′}}} )}^{2} \times BitCnt ( {i}^{′} )}$$

wherein pᵢ is the significance of the i-th bit row of the bit matrix in the matrix multiplication operation, Eᵢ is a bit value of the i-th bit row element, BitCnt(i) is a valid bit number in the i-th bit row, and l is the number of columns of the bit matrix.

The real-time pruning system for a neural network, before calling the module 1, acquiring a plurality of original weights to be subjected to the matrix multiplication operation, determining whether the original weights are fixed-point numbers, if yes, calling the module 1, or uniformly aligning all mantissas of the original weights to the maximum level code of the plurality of original weights, taking the aligned matrix as the bit matrix, and calling the module 1.

In the real-time pruning system for a neural network, the bit matrix is a weight matrix and/or an activation matrix; and the module 2 comprises: dividing N bit rows with the highest significance in the bit matrix into significant rows, where N is a positive integer, and less than a total number of bit rows of the bit matrix.

The application further provides a neural network accelerator applied to the real-time pruning system for a neural network.

The neural network accelerator comprises a PE formed of a plurality of CUs, each CU receiving a plurality of weight and activation pairs as inputs, and pruning processing on the input weights is performed by the module 2.

In the neural network accelerator, each selector of extractors in the CU is configured for a binary weight after pruning, and the extractors record the actual values of bits in each significant row for shifting the corresponding activations.

The application further provides a server comprising a storage medium, wherein the storage medium is configured to store and execute the real-time pruning method for a neural network.

### INDUSTRIAL APPLICABILITY

The application provides a hardware-based real-time pruning method and system for a neural network, and a neural network accelerator. The method comprises: acquiring, from a neural network model, a bit matrix to be subjected to matrix multiplication, and taking the Euclidean distance product of each bit row and each bit column of the bit matrix as the significance of each bit row of the bit matrix in a matrix multiplication operation; and classifying each bit row of the bit matrix into a significant row or an insignificant row according to the significance, and taking a matrix, which is obtained after bit positions that are 1 in the insignificant row of the bit matrix are set to 0, as a pruning result of the bit matrix. The application is a pruning method based on valid bits, and the method for determining validity of bits performs pruning without the aid on a software level, is independent of the existing software pruning method and supports multiple accuracy DNNs.

1. A real-time pruning method for a neural network, comprising:
step 1, acquiring, from a neural network model, a bit matrix to be subjected to matrix multiplication, and taking the Euclidean distance product of each bit row and each bit column of the bit matrix as the significance of each bit row of the bit matrix in a matrix multiplication operation; and
step 2, classifying each bit row of the bit matrix into a significant row or an insignificant row according to the significance, and taking a matrix, which is obtained after bit positions that are 1 in the insignificant row of the bit matrix are set to 0, as a pruning result of the bit matrix.

2. The real-time pruning method for a neural network according to claim 1, wherein the step 1 comprises the significance of each bit row of the bit matrix in a matrix multiplication operation obtained through the following formula:
$${p}_{i} = \frac{\sqrt{{( {2}^{{E}_{i}} )}^{2} \times BitCnt ( i )}}{C}$$
$$C = {\sum }_{{i}^{′} = 1}^{l} \sqrt{{( {2}^{{E}_{{i}^{′}}} )}^{2} \times BitCnt ( {i}^{′} )}$$
where pᵢ is the significance of the i-th bit row of the bit matrix in the matrix multiplication operation, Eᵢ is a bit value of the i-th bit row element, BitCnt(i) is a valid bit number in the i-th bit row, and l is the number of columns of the bit matrix.

3. The real-time pruning method for a neural network according to claim 1, before executing the step 1, acquiring a plurality of original weights to be subjected to the matrix multiplication operation, determining whether the original weights are fixed-point numbers, if yes, executing the step 1, or uniformly aligning all mantissas of the original weights to the maximum level code of the plurality of original weights, taking the aligned matrix as the bit matrix, and executing the step 1.

4. The real-time pruning method for a neural network according to claim 1, wherein the bit matrix is a weight matrix and/or an activation matrix; and the step 2 comprises: dividing N bit rows with the highest significance in the bit matrix into significant rows, where N is a positive integer, and less than a total number of bit rows of the bit matrix.

5. A real-time pruning system for a neural network, comprising:
a module 1 for acquiring, from a neural network model, a bit matrix to be subjected to matrix multiplication, and taking the Euclidean distance product of each bit row and each bit column of the bit matrix as the significance of each bit row of the bit matrix in a matrix multiplication operation; and
a module 2 for classifying each bit row of the bit matrix into a significant row or an insignificant row according to the significance, and taking a matrix, which is obtained after bit positions that are 1 in the insignificant row of the bit matrix are set to 0, as a pruning result of the bit matrix.

6. The real-time pruning system for a neural network according to claim 1, wherein the module 1 comprises the significance of each bit row of the bit matrix in a matrix multiplication operation obtained through the following formula:
$${p}_{i} = \frac{\sqrt{{( {2}^{{E}_{i}} )}^{2} \times BitCnt ( i )}}{C}$$
$$C = {\sum }_{{i}^{′} = 1}^{l} \sqrt{{( {2}^{{E}_{{i}^{′}}} )}^{2} \times BitCnt ( {i}^{′} )}$$
where pᵢ is the significance of the i-th bit row of the bit matrix in the matrix multiplication operation, Eᵢ is a bit value of the i-th bit row element, BitCnt(i) is a valid bit number in the i-th bit row, and l is the number of columns of the bit matrix.

7. The real-time pruning system for a neural network according to claim 1, before calling the module 1, acquiring a plurality of original weights to be subjected to the matrix multiplication operation, determining whether the original weights are fixed-point numbers, if yes, calling the module 1, or uniformly aligning all mantissas of the original weights to the maximum level code of the plurality of original weights, taking the aligned matrix as the bit matrix, and calling the module 1.

8. The real-time pruning system for a neural network according to claim 1, wherein the bit matrix is a weight matrix and/or an activation matrix; and the module 2 comprises: dividing N bit rows with the highest significance in the bit matrix into significant rows, where N is a positive integer, and less than a total number of bit rows of the bit matrix.

9. A neural network accelerator applied to the real-time pruning system for a neural network according to claim 5.

10. The neural network accelerator according to claim 9, comprising a PE formed of a plurality of CUs, each CU receiving a plurality of weight and activation pairs as inputs, and pruning processing on the input weights is performed by the module 2.

11. The neural network accelerator according to claim 9, wherein each selector of extractors in the CU is configured for a binary weight after pruning, and the extractors record the actual values of bits in each significant row for shifting the corresponding activations.

12. A server comprising a storage medium, wherein the storage medium is configured to store and execute the real-time pruning method for a neural network according to claim 1.
